(19) United States
(12) Patent Application Publication
(10) Pub. No.: US 2013/0096962 A1
(43) Pub. Date: Apr. 18, 2013

(54) SYSTEM AND METHOD OF MANAGING PROMOTIONS OF DIFFERENT GOODS OR SERVICES AT LODGING ESTABLISHMENTS

(71) Applicants: Jack W. Craig, Oviedo, FL (US); Rafael Yepez, Duluth, GA (US)

(72) Inventors: Jack W. Craig, Oviedo, FL (US); Rafael Yepez, Duluth, GA (US)

(73) Assignee: NCR CORPORATION, Duluth, GA (US)

(21) Appl. No.: 13/273,799

(22) Filed: Oct. 14, 2011

(51) Int. Cl. G06Q 30/02; G06Q 10/02

(52) U.S. Cl. 705/5

(57) ABSTRACT

A system and method of managing promotions of different goods or services at lodging establishments which is directed to reducing distressed inventories of a variety of different goods or services offered at the lodging establishments. An example method includes connecting to different property systems which manage sales of goods or services, obtaining reservation data and guest data from the different property systems, comparing the reservation data to predetermined thresholds to determine distressed inventories of the goods or services of the property systems, obtaining promotions directed to the distressed inventories, determining customers to receive the promotions of the distressed inventories, and sending the promotions to the customers.

### BACKGROUND

The present invention relates to promotions and managing inventory at lodging establishments and more specifically to a system and method of managing promotions of different goods or services at lodging establishments.

Lodging establishments and chains of lodging establishments often have available inventory, which may include available room reservations and room upgrades. In addition to distressed or underutilized inventory, lodging establishments often oversell rooms and need to relocate guests to alternate hotels.

Besides rooms, lodging establishments may offer other goods and services which may also be undersold or underutilized by guests or customers. For example, lodging establishments may have available inventory in restaurant reservations, golf reservations, spa reservations, and other available reservations for services. Lodging establishments may have gift shops and other stores which are underutilized by guests.

Management of available inventory is often handled by separate systems. For example, rooms and room reservations are often management by a Property Management System. Restaurant services and reservations are often managed by a Restaurant Management System. Golf services and reservations are often managed by a Golf Management System. Spa services and reservations are often managed by a Spa Management System. Gift shops and other stores are often managed by separate Point of Sale systems.

Currently, lodging establishments rely on front desk personnel to offer upgrades and other incentives when guests arrive at the lodging establishments; however, front desk personnel often forget to promote goods or services or skip promotions when they are busy in order to more quickly check-in guests. In addition, front desk personnel are usually not aware of additional “up sell” opportunities beyond room upgrades or up sell opportunities outside of their hotel. Therefore, guests never receive promotions for these goods or services.

Therefore, it would be desirable to provide a system and method of managing promotions of different goods or services at lodging establishments which overcomes these problems.

### SUMMARY

In accordance with the teachings of the present invention, a system and method of managing promotions of different goods or services at lodging establishments is provided.

An example method includes connecting to different property systems which manage sales of goods or services, obtaining reservation data and guest data from the different property systems, comparing the reservation data to predetermined thresholds to determine distressed inventories of the goods or services of the property systems, obtaining promotions directed to the distressed inventories, determining customers to receive the promotions of the distressed inventories, and sending the promotions to the customers.

### BRIEF DESCRIPTION OF THE DRAWINGS

FIG. 1 is a block diagram of a network of systems associated with a lodging establishment; and

FIG. 2 is a flow diagram of an inventory management method for a lodging establishment.

### DETAILED DESCRIPTION

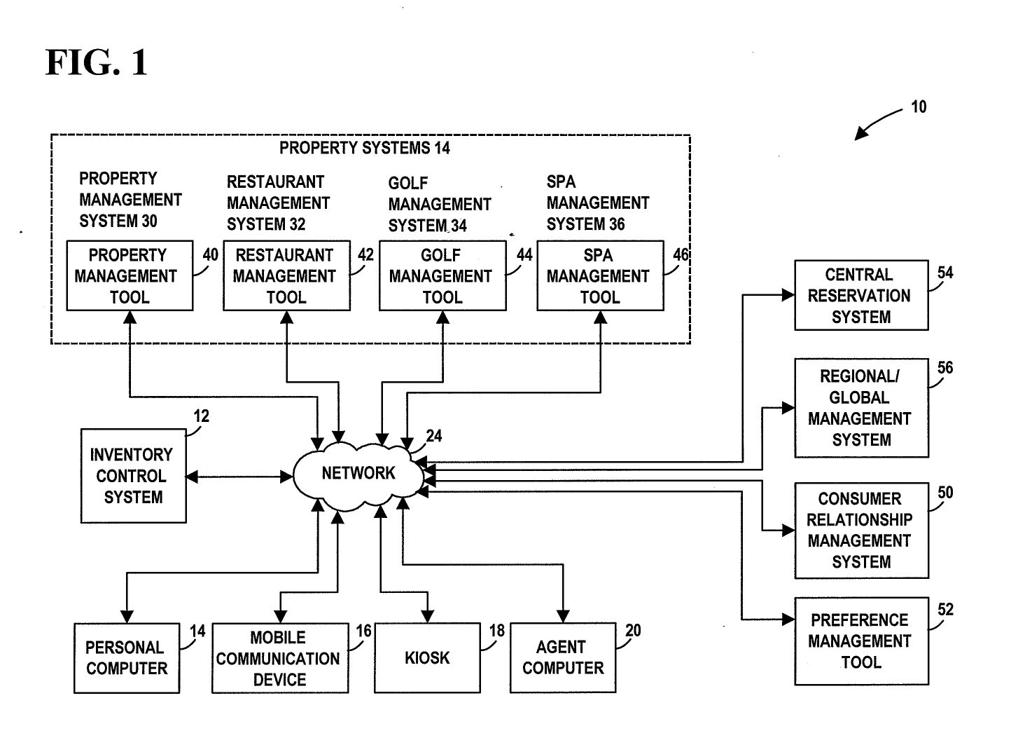

Turning now to FIG. 1, system 10 primarily includes inventory control system 12 and property systems 14.

Inventory control system 12 identifies distressed inventory and determines to whom promotions should be made. Distress may be based upon a variety of factors which may vary. For example, distress may be based upon numbers or percentages of available inventory, time inventory has been available, type of inventory, and other factors.

Inventory control system 12 aggregates promotion delivery for room and other services to guests, as opposed to guests receiving promotions solely directly from any one of property systems 14. Inventory control system 12 may aggregate promotions at a property level for a particular lodging establishment, or at a regional, national, or global level for a plurality of lodging establishments, such as a chain of lodging establishments.

Example property systems 14 include property management system 30, restaurant management system 32, golf management system 34, and spa management system 36. Other property systems 14 are also envisioned.

Each of property systems 14 separately maintain guest reservation data and guest data. Example guest reservation data may include rooms reserved, length of stay, room rate, group or company discount code, loyalty or other status, or other information. Example guest data may include guest profile information or guest preferences, guest loyalty status, guest reservation histories, and guest purchase histories.

Guest data may also include other information, such as when guests interact with property systems 14, what communication channels the guests use to interact with property systems 14, inputs from property systems 14, and data entered manually.

In one example embodiment, property management systems 14 may each include web servers with addresses for web sites for delivering web pages. Guests may download web pages for establishing and logging into accounts for making or cancelling reservations, checking loyalty status, and setting or changing preferences.

Property management system 30 manages guest services including room reservations at the lodging establishment. Property management system 30 includes a property management tool 40 that provides reservation information, guest information, and inventory information to inventory management system 12.

Restaurant management system 32 manages restaurant services including restaurant reservations at a restaurant adjacent to or co-located with the lodging establishment. Restaurant management system 32 includes a restaurant management tool 42 that provides reservation information, customer information, and inventory information to inventory management system 12.

Golf management system 34 manages golf services including tee time reservations at a golf course adjacent to or co-located with the lodging establishment. Golf management system 34 includes a golf management tool 44 that provides reservation information, customer information, and inventory information to inventory management system 12.

Spa management system 36 manages spa services including spa appointments at a spa adjacent to or co-located with the lodging establishment. Spa management system 36 includes a spa management tool 46 that provides reservation information, customer information, and inventory information to inventory management system 12.

Inventory control system 12 provides reservation data and guest data to consumer relationship management system 50. Inventory control system 12 may provide these data after determining that available inventory levels have reached predetermined distress thresholds.

Consumer relationship management system 50 generates promotions based upon the reservation data and the guest data. Consumer relationship management system 50 applies promotion rules against the reservation data and the guest data to identify guests for promotion delivery. Consumer relationship management system 50 may define guest circumstances or combinations of circumstances that would lead to promotions.

Example lodging promotions may include room upgrades to a present property, such as upgrade to a “club” or special membership level room from a standard room, and room upgrades to another property, such as when a present property is in an oversold situation.

Example restaurant promotions may include restaurant reservations and restaurant and lounge discounts.

Example golf promotions may include tee time reservations and golf discounts.

Example spa promotions may include spa reservations and spa discounts.

For example, consumer relationship management system 50 may provide inventory control system 12 with a room upgrade promotion to a guest staying only one night and paying a room rate greater than a predetermined amount when the lodging establishment is oversold on standard rooms and only has club rooms available. The promotion may solicit an upgrade fee in return for the upgrade, resulting in additional incremental revenue which otherwise may have been given away for free if the hotel ran out of standard rooms.

By soliciting guests for upgrades earlier, for example, up to twenty-four hours prior to arrival or whenever on-line check-in is allowed to start, the lodging establishment can solicit a larger number of guests, up until the point that all upgrades have been sold. This has the added benefit of freeing up hotel staff from making upgrade decisions, thus allowing them to focus on serving guests.

As another example, consumer relationship management system 50 may provide inventory control system 12 with a room upgrade promotion at another lodging establishment in the chain to a guest at the guest's reserved rate when the reserved lodging establishment is sold out. The promotion may require delivery be conditioned on the guest checking-in remotely, for example, via personal computer 14 or mobile communication device 16.

By offering this upgrade promotion to a guest in advance of arriving at the reserved lodging establishment, the guest is more likely to accept the offer and adjust travel plans accordingly, thus allowing the chain of lodging establishments to resolve the overbooked situation and earn revenue from both relocated guests and guests who would otherwise be without a room.

As another example, consumer relationship management system 50 may provide inventory control system 12 with promotions for other types of distressed or underutilized inventory at the same or at another lodging establishment in the chain besides vacant rooms. For example, consumer relationship management system 50 may provide promotions for spa appointments, golf tee times, and/or restaurant meals.

In addition to property systems 14, inventory control system 12 couples to and receives information from a preference management tool 52, a central reservation system 54, and a regional or global management system 56.

Preference management tool 52 provides inventory management system 12 with rules and thresholds for identifying available or distressed inventory and for determining when promotions should be delivered to guests to reduce the amount of available or distressed inventory.

Central reservation system 54 provides inventory management system 12 with new reservation information from prospective guests.

Regional or global management system 56 provides inventory management system 12 with reservation information and inventory levels from other properties.

Inventory control system 12 may include a processor, memory, and program and data storage. Inventory control system 12 may execute an operating system such as a Microsoft operating system. Inventory control system 12 may execute other computer software that may be stored in a computer readable medium, such as a memory. Inventory control system 12 may include one or more computers.

Inventory control system 12 further include graphics circuitry for connecting to a display, network circuitry for connecting to network 24, and other circuitry for connecting to other peripherals.

Network 24 may include any combination of wireless or wired networks, including a global communication network, also known as the Internet. In an example embodiment, inventory control system 12 connects with any of property systems 14 at a particular facility via secure network connection, such as an portal connection using a combination of the hypertext transfer protocol (HTTP) with secure socket layer (SSL)/transport layer security (TLS) protocol to provide encrypted communication, or a virtual private network (VPN) connection. Alternatively, inventory control system 12 may be part of a local or wide area network managed at a local property level, regional level, or global level.

Promotions may be obtained using personal computer 14, mobile communication device 16 (such as a smart phone), kiosk 18, and by interacting with an agent having an agent computer 20 that receives the promotions.

Personal computer 14, mobile communication device 16, kiosk 18, and agent computer 20 each include a processor, memory, and program and data storage. Each may execute an operating system such as a Microsoft operating system. Each may execute other computer software that may be stored in a computer readable medium, such as a memory.

Each of personal computer 14, mobile communication device 16, kiosk 18, and agent computer 20 may execute web browser software to display information in a format established by the World Wide Web (WWW or “web”). Web browser software may include commercially available web browser software, such as Microsoft® Internet Explorer web browser software. Each of personal computer 14, mobile communication device 16, kiosk 18, and agent computer 20 may connect to web servers of any of property systems 14 to changed preferences and make or cancel reservations.

Example ways in which guests may receive promotions include electronic mail (e-mail), simple message service or “text” message, multimedia message service (MMS), or other means.

Guests may also connect to property systems 14 to login to guest accounts and download promotions made available to these accounts by inventory management system 12.

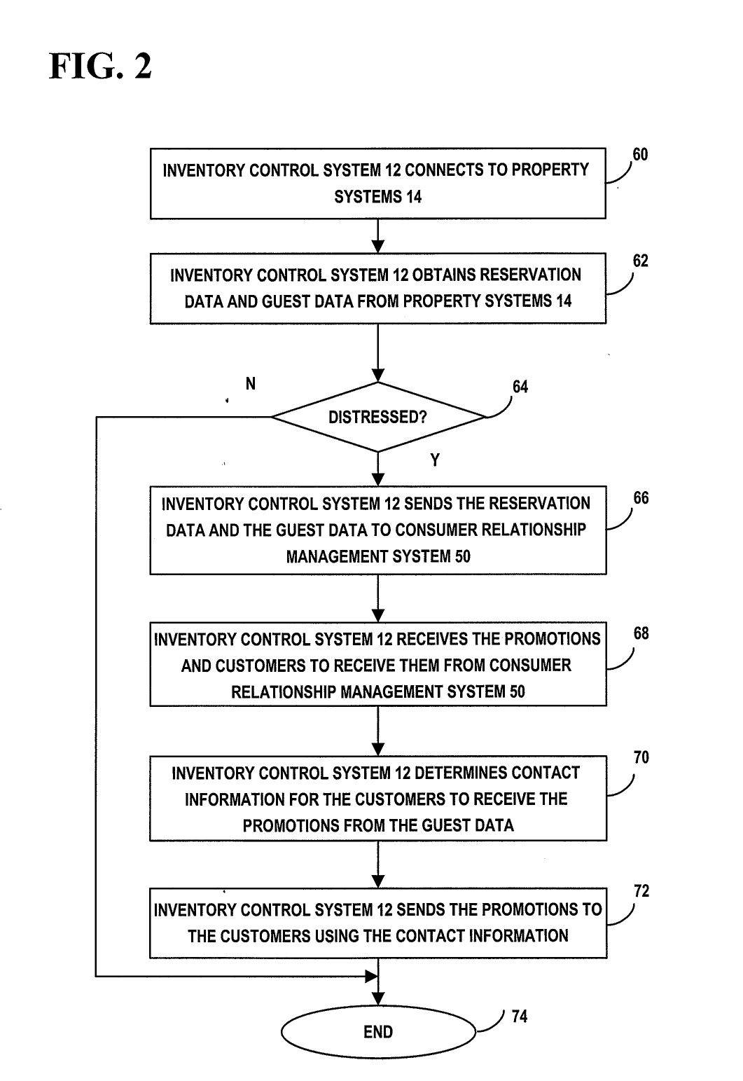

Turning now to FIG. 2, an example promotion method is illustrated in detail beginning with step 60.

In step 60, inventory control system 12 connects to one or more of property systems 14.

In step 62, inventory control system 12 obtains reservation data and guest data from property systems 14.

In step 64, inventory control system 12 compares reservation data to predetermined thresholds to determine whether any inventory of any of property systems 14 is distressed. If so, operation proceeds to step 66. Otherwise, operation ends at 74.

In step 66, inventory control system 12 sends the reservation data and the guest data to consumer relationship management system 50 to determine one or more promotions for the distressed inventory and to determine to whom to send them.

In step 68, inventory control system 12 receives the one or more promotions and identification of customers to receive them from consumer relationship management system 50.

In step 70, inventory control system 12 determines contact information for the customers to receive the one or more promotions from the guest data.

In step 72, inventory control system 12 sends the one or more promotions to the customers using the contact information.

Advantageously, inventory control system 12 manages promotion of distressed inventory of various types throughout a lodging establishment or group of lodging establishments. Inventory control system 12 has access to all property systems 14 and to property systems 14 of other properties.

Although the present invention has been described with particular reference to certain preferred embodiments thereof, variations and modifications of the present invention can be effected within the spirit and scope of the following claims.

What is claimed is:

1. A method of managing promotions of different goods or services at a lodging establishment comprising:
connecting to different property systems which manage sales of the different goods or services by a computer;
obtaining reservation data and guest data from the different property systems by the computer;
comparing the reservation data to predetermined thresholds to determine distressed inventories of the different goods or services of the property systems by the computer;
obtaining promotions directed to the distressed inventories managed by the different property systems and customer information associated with the promotions by the computer; and
providing the promotions to customers using the customer information by the computer.

2. The method of claim 1, wherein one of the different property systems comprises a property management system and the different goods and services comprise lodging services.

3. The method of claim 1, wherein one of the different property systems comprises a restaurant management system and the different goods and services comprise restaurant services.

4. The method of claim 1, wherein one of the different property systems comprises a golf management system and the different goods and services comprise golf services.

5. The method of claim 1, wherein one of the different property systems comprises a spa management system and the different goods and services comprise spa services.

6. The method of claim 1, wherein the connecting step comprises connecting through a virtual private network connection.

7. The method of claim 1, wherein the connecting step comprises connecting through a portal network connection.

8. The method of claim 1, wherein the predetermined thresholds are based upon numbers of available inventories.

9. The method of claim 1, wherein the predetermined thresholds are based upon times inventories have been available.

10. The method of claim 1, wherein the predetermined thresholds are based upon types of inventories.

11. The method of claim 1, wherein the obtaining step comprises:
sending the reservation data and the guest data to a customer relationship management system; and
receiving the promotions and the customer information from the customer relationship management system.

12. The method of claim 1, wherein the providing step comprises sending the promotions to the customers by the computer.

13. The method of claim 12, wherein the sending step comprises sending the promotions to mobile communication devices of the customers by the computer.

14. The method of claim 1, wherein the promotions are directed to the goods or services offered at the lodging establishment.

15. The method of claim 1, wherein the promotions are directed to other goods or services offered at other lodging establishments.

16. The method of claim 1, wherein the providing step comprises providing the promotions to the customers before the customers arrive at the lodging establishment.

17. An inventory control system for a lodging establishment which offers a plurality of different goods or services including at least lodging services, the system comprising:
a computer for connecting to a plurality of different property systems which manage sales of the different goods or services at the lodging establishment, wherein the different property systems include at least a property management system which manages sales of the lodging services, for obtaining reservation data and guest data from the different property systems, for comparing the reservation data to predetermined thresholds to determine distressed inventories of the different goods or services of the property systems, for obtaining promotions directed to the distressed inventories managed by the different property systems and customer information associated with the promotions, and for providing the promotions to customers using the customer information.

18. The system of claim 15, wherein the computer connects to the different property systems through a portal network connection.

19. The system of claim 15, wherein the computer sends the promotions to mobile communication devices of the customers before the customers arrive at the lodging establishment.

20. The system of claim 15, wherein the promotions are directed to other goods or services offered at other lodging establishments.
